(19) United States
(12) Patent Application Publication
(10) Pub. No.: US 2007/0146320 A1
(43) Pub. Date: Jun. 28, 2007

(54) INFORMATION INPUT SYSTEM

(75) Inventor: Akira Kubota, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/614,629

(22) Filed: Dec. 21, 2006

(30) Foreign Application Priority Data
Dec. 22, 2005 (JP) 2005-369191

(51) Int. Cl. G09G 5/08; H04J 3/00; H04J 3/22

(52) U.S. Cl. 345/157; 345/173

(57) ABSTRACT

An information input system includes a projector capable of projecting an operation screen image for making an input operation of information to a computer, and an image pickup device capable of sending picked-up image data acquired by picking up the operation screen image to the computer, wherein, as a predetermined position on the operation screen image is designated with a designating unit as the input operation, the designated position is detected as an input operation position on the basis of the picked-up image data, and a pointer is displayed at the detected input operation position by the projector. The information input system further includes a standstill period determining unit that finds a time period during which the designating unit holds a standstill state at the input operation position as a standstill period, and determines whether the found standstill period has reached a predetermined time period or not, and an input operation information generating unit that generates input operation information indicating that an input operation at the input operation position has been executed if it is determined that the standstill period has reached the predetermined time period.

### BACKGROUND

1. Technical Field

The present invention relates to an information input system that enables input of information to a computer, an information input method for an information input system, and an information input program for an information input system.

2. Related Art

Input of information to a computer or the like is made typically by using a mouse and keyboard. For example, in the case of inputting position information or the like by using a mouse, an operator operates the mouse on the desk while watching the computer screen to make input.

In such an operation, since the mouse operating position on the desk is away from the information input position on the computer screen, the operator may find it uncomfortable to make a perceptual input. To deal with this situation, some computers have a touch sensor function on the screen. This touch sensor allows the information input position by the operator to coincide with the actual information input position, and the operator actually touches the information input position. Therefore, it is advantageous in that a perceptual feedback is provided. However, the provision of a touch panel simply as a position information input unit increases the device scale and also has a problem of cost.

Recently, various types of information input systems having a man-machine interface that is not conscious of the computer have been proposed, for example, as disclosed in JP-A-7-84715 and JP-A-2000-298544.

The technique disclosed in JP-A-7-84715 enables the operator to operate, by gestures, a document image projected on a desk-like flat display screen by a projector. For example, a document image displayed on the flat display screen can be moved to an arbitrary position on the flat display screen by the operator's hand, or an operation of turning pages or the like can be made on the flat display screen.

In the technique disclosed in JP-A-2000-298544, an operation screen image including a keyboard and an operation screen is projected on a desk by a projector, and the operator can input information on the operation screen image projected on the desk.

The technique disclosed in JP-A-7-84715 enables operation of an object displayed on the flat display screen in such a way as if the operator were operating an actually existing object. The operator makes gestures that have been set corresponding to various operations to the document image, and each gesture is picked up by an image pickup device. Of the picked-up image data, the gesture made by the operator is recognized and processing corresponding to the result of recognition is performed. Therefore, the operator must remember particular gestures corresponding to various operations and make a gesture corresponding to a certain operation.

In the technique disclosed in JP-A-2000-298544, an operation screen image is projected on the desk by the projector, and input of characters and the like from the keyboard on the operation screen image and operation of a pointer or icon on the operation screen image can be made. In this technique disclosed in JP-A-2000-028544, which input operation is made by the operator is identified on the basis of the various hand movements by the operator, as in the technique disclosed in JP-A-7-84715.

In the technique disclosed in JP-A-2000-298544, for example, in the case of moving a pointer image of a cursor or the like displayed on the operation screen image, the operator designates at the pointer image with a fingertip and moves it to a desired position. After that, if the position is to be decided, the operator performs an action of sticking out the finger next to the finger designating the pointer at the position that should be decided. When moving an icon, the operator performs an action of nipping the icon with two fingertips and moving it.

Most of the fingertip actions set in JP-A-2000-298544 are unnatural actions that are not usually carried out in everyday life, and the operator must remember various fingertip actions corresponding to specific operations. Therefore, ordinary operators who are not skilled in input operations cannot easily perform these actions.

### SUMMARY

Thus, an advantage of some aspects of the invention is to provide an information input system that enables input of information to a computer by a simple operation of a designating unit like a fingertip and thereby enables an ordinary operator who is not skilled in input operations to easily use the system, an information input method for an information input system, and an information input program for an information input system.

According to a first aspect of the invention, an information input system includes a projector capable of projecting an operation screen image for making an input operation of information to a computer, and an image pickup device capable of sending picked-up image data acquired by picking up the operation screen image to the computer. As a predetermined position on the operation screen image is designated with a designating unit as the input operation, the designated position is detected as an input operation position on the basis of the picked-up image data, and a pointer is displayed at the detected input operation position by the projector. The information input system includes a standstill period determining unit that finds a time period during which the designating unit holds a standstill state at the input operation position as a standstill period, and determines whether the found standstill period has reached a predetermined time period or not, and an input operation information generating unit that generates input operation information indicating that an input operation at the input operation position has been executed if it is determined that the standstill period has reached the predetermined time period.

With the information input system according to the first aspect of the invention, when making an input operation of information to the computer, input operation information indicating the execution of input operation can be provided to the computer simply by performing an operation of stopping the designating unit for a predetermined period of time at a desired input operation position on the operation screen image projected by the projector. Thus, the information input system has a man-machine interface function that can be easily used by an operator who is not skilled in input operations.

It is preferable that the information input system according to the first aspect of the invention further includes an input operation display control unit that makes a display to show the operator that the input operation has been executed if it is determined that the standstill period has reached the predetermined time period.

As such an input operation display control unit is provided, it can show the operator that the input operation has been executed. Thus, the operator can learn that the input operation he or she made has been executed, and can have a sense of safety in performing operations.

It is also preferable that, in the information input system, when the input operation is an operation of moving the designating unit from the input operation position corresponding to the start of the input operation to an input operation position corresponding to the end of the input operation, the input operation display control unit makes different displays at least between the input operation position corresponding to the start of the input operation and the input operation position corresponding to the end of the input operation.

The input operation in this case may be, for example, a drawing operation of drawing a line or the like. When performing such a drawing operation, as different displays are made between the input operation position corresponding to the start of the input operation and the input operation position corresponding to the end of the input operation, the operator can check the state of the drawing operation he or she carried out, and the operability of the drawing operation can be improved.

It is also preferable that, in the information input system, the display to show the operator that the input operation has been executed is made in such a manner that the pointer is displayed to the operator with a visually perceptible change.

As the pointer is thus displayed to the operator with a visually perceptible change, the operator can visually check that the input operation he or she carried out has been executed. The display with a visually perceptible change may be, for example, a chance in the color or shape of the pointer, or flashing of the pointer. The change in the color or shape, the flashing and the like can be combined.

It is also preferable that, in the information input system according to the first aspect of the invention, the standstill period determining unit has a standstill state determining function that determines whether or not the designating unit is in a standstill state at the input operation position. The standstill state determining function determines whether a shift of the designating unit from the input operation position is within a predetermined range in the predetermined time period, and determines that the designating unit is in a standstill state at the input operation position if the shift from the input operation position is within the predetermined range.

As the standstill period determining unit has such a standstill state determining function, it can be determined whether the designating unit is in a standstill state at the input operation position. An allowable range is provided with respect to the positional shift of the designating unit from the input operation position. To raise the detection accuracy for detecting the input operation position, it is preferable that the allowable range, that is, the allowable shift, is as small as possible. However, if it is too small, the input operability for the operator is lowered. An optimum value is set in consideration of these points.

It is also preferable that, in the information input system according to the first aspect of the invention, the designating unit is the operator's fingertip and the input operation position is detected by detecting the fingertip.

As the operator's fingertip is assumed to be the designating unit, the operator can make an input as he or she likes, easily and naturally, without using any other particular designating unit.

According to a second aspect of the invention, an information input method is for an information input system that includes a protector capable of projecting an operation screen image for making an input operation of information to a computer, and an image pickup device capable of sending picked-up image data acquired by picking up the operation screen image to the computer, and in which as an operator designates a predetermined position on the operation screen image with a designating unit as the input operation, the designated position is detected as an input operation position on the basis of the picked-up image data, and a pointer is displayed at the detected input operation position by the projector. The information input method includes finding a time period during which the designating unit holds a standstill state at the input operation position as a standstill period and determining whether the found standstill period has reached a predetermined time period or not, and generating input operation information indicating that an input operation at the input operation position has been executed if it is determined that the standstill period has reached the predetermined time period.

The information input method for the information input system has the same effects as in the information input system according to the first aspect of the invention. It is preferable that the information input method for the information input system has the above-described features of the information input system.

According to a third aspect of the invention, an information input program is for an information input system that includes a projector capable of projecting an operation screen image for making an input operation of information to a computer, and an image pickup device capable of sending picked-up image data acquired by picking up the operation screen image to the computer, and in which as an operator designates a predetermined position on the operation screen image with a designating unit as the input operation, the designated position is detected as an input operation position on the basis of the picked-up image data, and a pointer is displayed at the detected input operation position by the projector. The information input program enables the computer to execute finding a time period during which the designating unit holds a standstill state at the input operation position as a standstill period and determining whether the found standstill period has reached a predetermined time period or not, and generating input operation information indicating that an input operation at the input operation position has been executed if it is determined that the standstill period has reached the predetermined time period.

The information input program for the information input system has the same effects as in the information input system according to the first aspect of the invention. It is preferable that the information input program for the information input system has the above-described features of the information input system.

### BRIEF DESCRIPTION OF THE DRAWINGS

The invention will be described with reference to the accompanying drawings, wherein like numbers reference like elements.

FIG. 1 shows an appearance and configuration of an information input system according to an embodiment of the invention.

FIG. 2 is a block diagram showing a configuration of an information input system according an embodiment of the invention.

FIGS. 3A to 3C show exemplary changes of the display state of a pointer corresponding to an input operation by an operator.

FIG. 4 is a block diagram showing a configuration of an information input device that realizes a function of an information input system according to an embodiment or the invention.

FIGS. 5A to 5D illustrate a case where, as an input operation by an operator, the operator performs a drawing operation on an operation screen image.

FIG. 6 is a flowchart for explaining a flow of processing on the computer side, starting with detection of an input operation position with respect to an input operation by an operator, up to a change in the display state of a pointer.

FIG. 7 shows an appearance and configuration of a modification of an information input system according to an embodiment of the invention.

### DESCRIPTION OF EXEMPLARY EMBODIMENTS

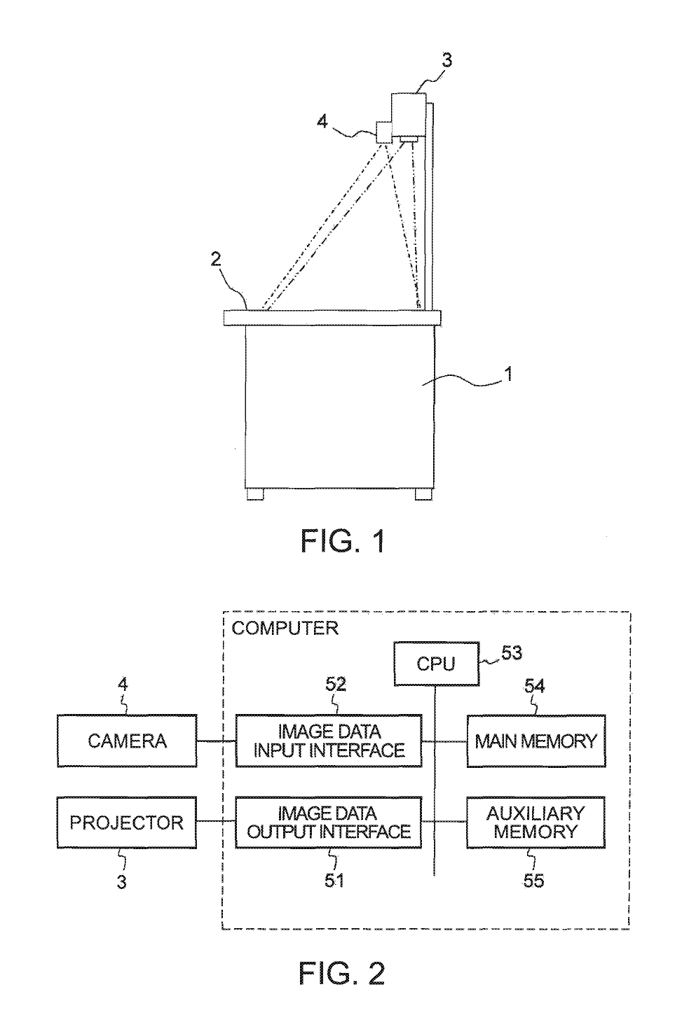

FIG. 1 shows an appearance and configuration of an information input system according to an embodiment of the invention. As shown in FIG. 1, the information input system according to this embodiment of the invention has a projector 3 installed to be capable of projecting an operation screen image onto a work surface 2 of a desk 1, an image pickup device 4 installed to be capable of picking up the operation screen image projected by the projector 3, and a computer 5 (see FIG. 2) such as a personal computer, not shown in FIG. 1.

FIG. 2 is a block diagram showing a configuration of the information input system according to the embodiment of the invention. As shown in FIG. 2, the projector 3 is connected to an image data output interface 51 of the computer 5, and the image pickup device 4 is connected to an image data input interface 52 of the computer 5. In addition to the image data output interface 51 and the image data input interface 52, the computer 5 has a CPU 53 that executes various processing as a computer, a main memory 54, an auxiliary memory 55 and the like.

Now, the case of performing an information input operation to the computer 5 will be schematically described. First, an operator holds out a certain form of designating unit (in this embodiment, it is a fingertip) to the operation screen image projected on the work surface 2 of the desk 1, and then a pointer is displayed near the edge of the fingertip that has been held out. In this case, the image pickup device 4 picks up the operation screen image at predetermined frame intervals and sends the picked-up image data to the computer 5. The computer 5 detects the fingertip of the operator on the basis of the picked-up image data from the image pickup device 4.

The detection of the fingertip can be carried out, for example, by a technique of extracting a hand image based on the difference from the background or extracting a hand image based on the detection of skin color, and then considering the characteristics of the fingertip with respect to the outline of the hand image, thus detecting the fingertip. However, in this invention, the detection technique is not particularly limited and the fingertip can be detected by any technique.

As such detection of the fingertip is carried out, input operation position information indicating the position where the operator made the input operation (input operation position) is generated by the computer. To make an input operation to the computer 5, information indicating that the input operation has been executed (input operation information) needs to be generated by the computer 5, in addition to the input operation position information. This input operation information corresponds to, for example, information indicating whether a button of a mouse has been pressed or not, in the case of an operation by a mouse.

It is assumed that the input operation information is generated by using the time period during which the operator's fingertip is standstill. That is, it is determined whether the operator's fingertip is standstill (standstill state) or not at the input operation position, and if it is determined that the fingertip is in the standstill state, it is then determined whether the time period during which the standstill state is held has reached a predetermined time period (first threshold value) or not. If the period of the standstill state has reached the first threshold value, the input operation information is generated. The first threshold value will be described later.

To determine whether the fingertip is in the standstill state or not, a threshold value (second threshold value) for determining whether it is the standstill state is set, and the determination is made on the basis of the second threshold value and picked-up image data of each frame acquired from the image pickup device 4.

Specifically, in accordance with whether |Xf−Xi|≦δ is met, whether it is the standstill state or not is determined. Here, Xf represents the input operation position acquired from the latest picked-up image data, and Xi represents the input operation position for the frame preceding the frame of the latest picked-up image data by (N+1) frames. These Xf and Xi are expressed as coordinate values of the image pickup element of the image pickup device 4. N represents the number of consecutive frames that are determined as showing the standstill state at that time, and δ represents the second threshold value set for determining whether it is the standstill state or not.

The second threshold value shows the allowable range of shift of the fingertip from the input operation position. A value is set that allows a small shift of the fingertip to be regarded as standstill. However, to realize high detection accuracy for the input operation position, it is preferable that the allowable shifts should be as small as possible. If it is expressed by a specific distance, it is preferable that a shift of the fingertip within a range of 4 mm in radius is regarded as an allowable range. This means that even if the fingertip shifts within the range of 4 mm in radius, it is regarded as the standstill state. In this case, the second threshold value is 4 mm.

The determination about whether it is the standstill state is based on whether |Xf−Xi|≦δ is met or not, that is, based on whether the difference from the position of the fingertip not in the immediately preceding frame but in the frame that is preceding by several frames is equal to or less the second threshold value δ, in order to prevent the following situation. For example, if the operator shifts the fingertip slightly each time (in this case, 4 mm or less each time), each shift of the fingertip between frames next to each other is equal to or less than the threshold value and it is determined that the fingertip is in the standstill state. If the operator continues the operation, it can be determined that the fingertip is in the standstill state even though the total amount of the shifts exceeds the allowable range. Such a situation is prevented by the above-mentioned way of determination.

As described above, if it is determined that the fingertip is in the standstill state as a result of the determination based on whether |Xf−Xi|≦δ is met or not, it is then determined whether the time period (standstill period) during which the standstill state continues has reached the first threshold value or not. When the standstill period has reached the first threshold value, the computer 5 considers that an input operation has been executed by the operator at the input operation position, and then generates input operation information and carries out processing corresponding to the input operation by the operator.

That is, when the operator executes an input operation at the input operation position, the operator can take an action of holding the standstill state of the fingertip at the input operation position for a period corresponding to the first threshold value or more. Thus, the computer 5 generates input operation information and performs processing corresponding to the input operation by the operator.

If the standstill period as the first threshold value is too short, it is difficult for the operator to make the intended operation. If it is too long, the operator must hold the standstill state of the fingertip until the time period ends and the operability is lowered. Considering these points, it is preferable that a time period of 0.5 to 1 second is set as the first threshold value.

The computer 5 generates the input operation information and presents a certain form of display that enables the operator to visually recognize the execution of the input operation carried out by this operator, in accordance with the input operation executed by the operator. Specifically, the display state of the pointer displayed near the fingertip is changed.

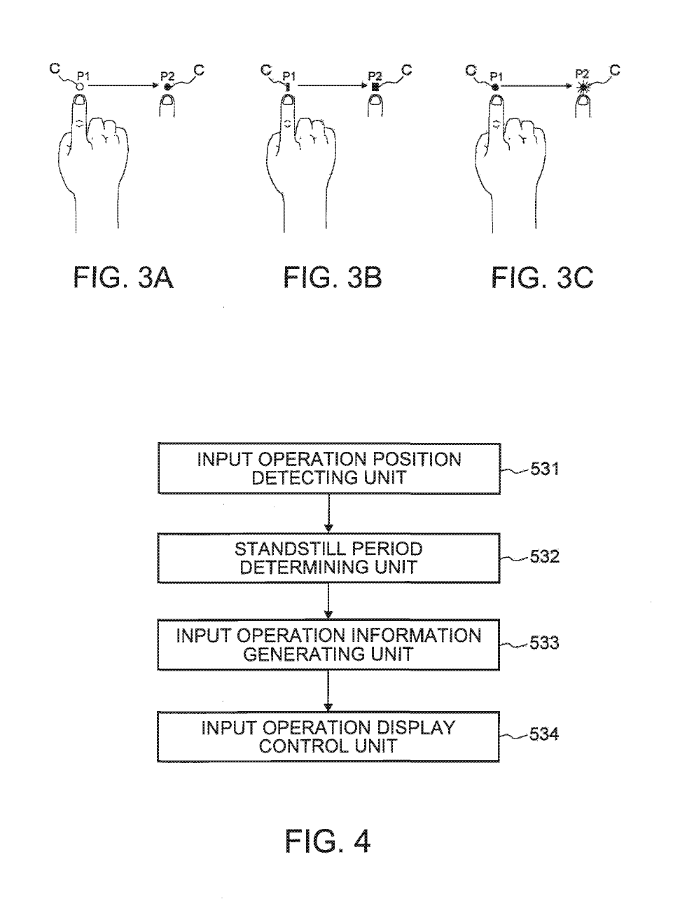

FIGS. 3A to 3C show exemplary changes of the display state of the pointer corresponding to the input operation by the operator. FIG. 3A shows an example where a pointer C is displayed in different colors when an input operation is executed at each input operation position. In FIG. 3A, when the standstill period at an input operation position P1 has reached the first threshold value, the pointer C is displayed in red, and when the fingertip is shifted in the direction of the arrow in this state, the pointer C follows the fingertip and shifts while it is still displayed in red. Then, when the fingertip is stopped at an input operation position P2 and the standstill period of the fingertip at the input operation position P2 has reached the first threshold value, the display of the pointer turns blue.

FIG. 3B shows an example where the pointer C is displayed in different shapes when an input operation is executed at each input operation position. In FIG. 3B, when the standstill period at the input operation position P1 has reached the first threshold value, the pointer is displayed in a linear shape, and when the fingertip is shifted in the direction of the arrow in this state, the pointer C follows the fingertip and shifts while it is still displayed in the linear shape. Then, when the fingertip is stopped at the input operation position P2 and the standstill period of the fingertip at the input operation position P2 has reached the first threshold value, the displayed shape of the pointer turns into a quadrilateral such as a square.

FIG. 3C shows an example where the pointer C is displayed by continuous lighting and by flashing when an input operation is executed at each input operation position. In FIG. 3C, when the standstill period at the input operation position P1 has reached the first threshold value, the pointer is displayed by continuous lighting, and when the fingertip is shifted in the direction of the arrow in this state, the pointer C follows the fingertip and shifts while it is still displayed by continuous lighting. Then, when the fingertip is stopped at the input operation position P2 and the standstill period of the fingertip at the input operation position P2 has reached the first threshold value, the display of the pointer is switched to flashing.

As the operator is thus enabled to visually identify the state of the input operation in accordance with the input operation carried out by the operator, the operator can carry out his or her input operation while visually checking it. In the examples shown in FIGS. 3A to 3C, the color or shape of the pointer is changed, or the pointer is flashed. These can be combined. It is also possible that a different display is shown during the shift.

FIG. 4 is a block diagram showing a configuration of an information input device that realizes the functions of the information input system according to the embodiment of the invention. The informant on input device has: an input operation position detecting unit 531 that detects an input operation position by detecting a fingertip; a standstill period determining unit 532 having a standstill state determining function that determines whether the fingertip is in a standstill state at the input operation position detected by the input operation position detecting unit, on the basis of the second threshold value, and a function to measure a time period (standstill period) during which the standstill state is determined by the standstill state determining function and to determine whether the measured standstill period has reached the first threshold value or not; an input operation information generating unit 533 that generates input operation information indicating that the input operation has been executed when it is determined by the standstill period determining unit 532 that the standstill period is equal to or more than the first threshold value; and an input operation display control unit 534 that makes a display for showing the operator that the input operation has been executed, on the basis of the input operation information generated by the input operation information generating unit 533, as shown in FIG. 4.

The input operation display control unit 534 is for carrying out, for example, the switching of the display state of the pointer as described with reference to FIGS. 3A to 3C. The processing carried out by these elements is executed as a process in the CPU 53 of the computer 5.

Next, specific input operations carried out by the operator will be described. It is assumed here that the switching of the display state of the pointer C corresponding to the input operation by the operator is done by switching the color of the pointer C as shown in FIG. 3A.

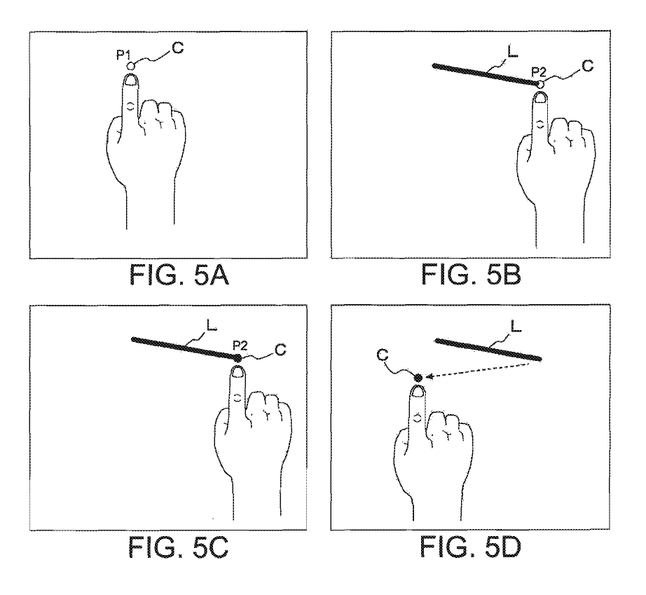

FIGS. 5A to 5D illustrate a case where, as an input operation carried out by an operator, the operator makes a drawing operation on the operation screen image projected on the work surface 2 of the desk 1. It is now assumed that the operator has carried out an input operation of stopping the fingertip at the input operation position P1, as shown in FIG. 5A. In this state, when the standstill period of the fingertip at the input operation position P1 has reached the first threshold value (in this embodiment, a time period of 0.5 to 1 second is set), the computer 5 generates input operation information, carries out processing to enable a drawing operation, and performs control to display the pointer C in red.

The operator checks that the pointer C is displayed in red, and thereby recognizes that the input operation he or she made has been executed and the drawing operation is enabled (drawing state) . Thus, as the operator moves the fingertip in the drawing state, a line L is displayed on the locus, as shown in FIG. 5B.

Then, it is assumed that as an input operation to temporarily end the drawing operation, the operator stops the movement of the fingertip at the input operation position P2 and holds the fingertip in the standstill state at the input operation position P2, as shown in FIG. 5C. When the standstill period of the fingertip has reached the first threshold value at the input operation position P2, the computer 5 generates input operation information, performs processing to temporarily end the drawing state at the input operation position P2 to create a non-drawing state, and performs control to display the pointer C in blue.

The operator checks that the pointer C is displayed in blue, and thereby recognizes that the non-drawing state has set in at the input operation position P2. In this manner, when the pointer has turned blue, if the operator moves the fingertip as indicated by a dotted-line arrow as shown in FIG. 5D, the pointer C moves together with the finger but no drawing is made.

In this embodiment, it is preferable that a time period of 0.5 to 1 second is set as the first threshold value. However, as described above, if the first threshold value is too small, it may be difficult for the operator to carry out his or her intended operation, whereas if the first threshold value is too large, the operability is lowered.

Here, as the state where “it may be difficult for the operator to carry out his or her intended operation”, which is the problem in the case of setting the first threshold value at too small a value, it may be considered that the pointer turns blue before a series of drawing operations intended by the operator ends. For example, while performing the drawing operation starting at FIG. 5A to reach FIG. 5B, that is, the drawing operation in which the operator moves the fingertip while the pointer C is displayed in red, the operator may temporarily stop the movement of fingertip and then resume the movement of the fingertip immediately. In such a case, if the first threshold value is set at too small a value, the display of the pointer may turn blue immediately before the operator resumes the movement of the fingertip. To prevent occurrence of such a situation, it is considered preferable that the lower limit of the first threshold value is approximately 0.5 seconds.

In FIGS. 5A to 5D, the example of performing the drawing operation is described. However, the invention can also apply to the case of performing an operation of moving an icon or the like. Although not shown in the drawings, when an icon as a moving target is designated by the operator's fingertip, a pointer is displayed on the icon, and when the standstill period of the operator's fingertip has reached the first threshold value, the pointer is displayed in red. As the fingertip is moved in this state, the designated icon follows the movement of the fingertip and moves. When it has reached a desired position, the operator stops the movement of the fingertip. When the standstill period of the fingertip at the position has reached the first threshold value, the pointer at this position turns blue. In the state where the pointer has turned blue, the icon does not move even if the operator moves the fingertip.

It is preferable that the pointer display position with respect to the operator's fingertip is arranged to avoid displaying the pointer C on the fingertip itself. That is, the pointer C is displayed as a projected image from the projector 3, and if processing to display the pointer C exactly at the detection position of the fingertip by the fingertip detection on the computer 5 is performed, the pointer C is displayed in a state of being superimposed on the operator's fingertip. The operator will have difficulty in visually recognizing the pointer C and may not be able to easily carry out operations such as the drawing operation.

To address such a circumstance, it is preferable that the pointer C is displayed not at the detection position of the fingertip itself but at a position that is slightly shifted from the edge of the fingertip and that enables such visual recognition as if the fingertip and the pointer were integrated, as shown in FIGS. 3A to 3C and FIGS. 5A to 5D.

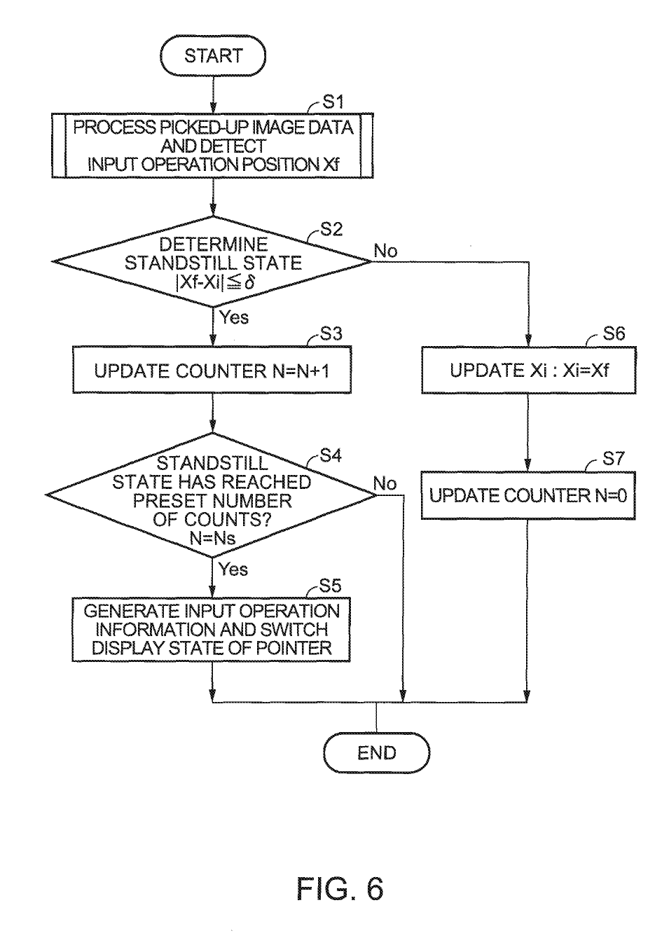

FIG. 6 is a flowchart for explaining a flow of processing on the computer side, stating with the detection of an input operation position with respect to an input operation carried out by the operator and up to the switching of the display state of the pointer.

As shown in FIG. 6, first, as the operator's fingertip designates a predetermined position, the image pickup device picks up this state, and the computer takes the picked-up image, performs image processing and detects an input operation position Xf (step S1). It is determined whether the fingertip is in the standstill state or not, on the basis of the detected input operation position Xf (step S2) The determination about whether it is the standstill state or not is based on the determination about whether |Xf−Xi| is equal to or less than the second threshold value δ, that is, whether |Xf−Xi|≦δ is met or not, as described already.

If it is determined in step S2 that |Xf−Xi|≦δ is met, that is, it is the standstill state, a counter to count the number of consecutive standstill frames N is updated (N=N+1) (step 53). Next, it is determined whether the number of consecutive standstill frames N (the number of consecutive frames N updated in step S3) has reached a preset number of counts Ns (the number of frames corresponding to a time period set as the first threshold value) or not (step S4). If the number of consecutive standstill frames N has reached the preset number of counts Ns, input operation information is generated and the display state of the pointer C is switched (step S5).

If it is determined in step S2 of the flowchart of FIG. 6 that |Xf−Xi|≦δ is not met and that it is not the standstill state, Xi is updated to Xi=Xf (step S6) Then, the counter is updated to N=0 (step S7).

The processing of steps S2, S4 and S5 in the flowchart shown in FIG. 6 will now be made to correspond to, for example, the drawing operation shown in FIG. 5A and the drawing operation shown in FIG. 5C. In FIG. 5A, the processing of step S2 in FIG. 6 is to determine whether the fingertip is in the standstill state or not, by determining whether the shift of the input operation position P1 acquired from the picked-up image data is equal to or less than the second threshold value δ (=4 mm). In FIG. 5C, the processing of step S2 is to determine whether the fingertip is in the standstill state or not, by determining whether the shift of the input operation position P2 acquired from the picked-up image data is equal to or less than the second threshold value δ (=4 mm).

In FIG. 5A, the processing of steps S4 and S5 in FIG. 6 is to generate input operation information at the input operation position P1 and switch the display of the pointer to red when the standstill period of the fingertip at the input operation position P1 has reached the first threshold value (for example, if the first threshold value is one second, the number of frames corresponding to one second). In FIG. 5C, the processing is to generate input operation information at the input operation position P2 and switch the display of the pointer to blue when the standstill period of the fingertip at the input operation position P2 has reached the first threshold value.

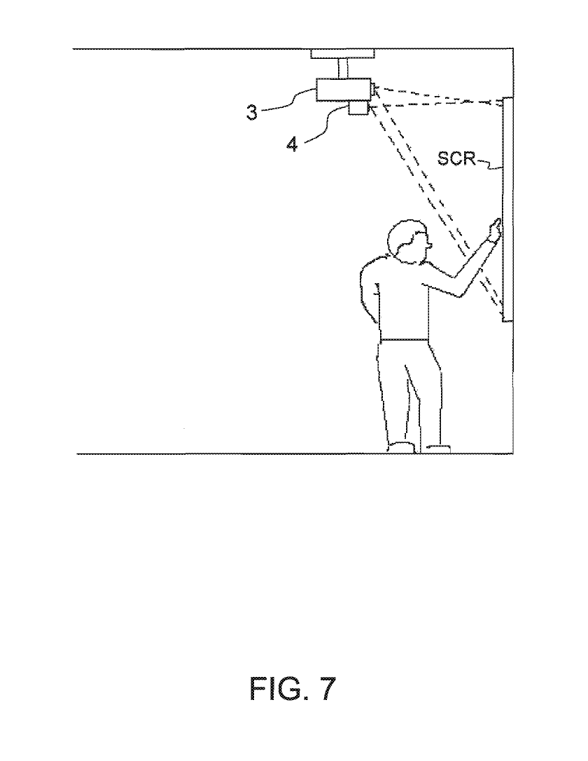

The invention is not limited to the above embodiment and various modifications can be made without departing from the scope of the invention. For example, while the work surface in the embodiment substantially horizontal, the work surface may be vertical as shown in FIG. 7. That is, as shown in FIG. 7, with a screen SCR installed on the sidewall or the like of the room and with the projector 3 and the image pickup device 4 hanging from the ceiling, an operation screen image may be displayed onto the screen SCR from the projector 3 and the operator can carry out the input operation described with reference to FIGS. 5A to 5D on the operation screen image displayed on the screen SCR. This state may be picked up by the image pickup device 4.

In the embodiment, the first threshold value is set as a time period of 0.5 to 1 second and the second threshold value is set at 4 mm. However, the first threshold value and the second threshold value are not limited to these values. Particularly, it is preferable that the first threshold value can be set at an optimum value in accordance with the preference of the operator who uses the information input system according to an embodiment of the invention, the operator's skill in operations, the contents of input operations and the like.

While the projector 3 in the embodiment is of a forward projection type, the projector 3 may be of a rear projection type and projection may be carried out from the rear side of the work surface 2 (in FIG. 7, the screen SCR).

In the embodiment, the input operation display control unit 534 changes the color or shape of the pointer, or flashes the pointer (see FIGS. 3A to 3C), as the unit for making a display to notify the operator that the input operation has been executed. However, it maybe output a short electronic sound like a beep sound. In this case, in the case of drawing, the type of sound may be varied between the drawing start position and the end position, and the operator can easily distinguish the operating state. It is also possible to combine changes in the color or shape of the pointer, flashing of the pointer, and sounds.

In the embodiment, the designating unit of the operator is the operator's fingertip, but it is not limited to the fingertip. For example, various designating units can be used such as a pen, a pointer bar, and a laser pointer.

Also, an information input program to be executed by the computer of the information input system according to the embodiment can be produced, and the produced information input program can be recorded on various recording media. Therefore, the invention includes a recording medium on which the information input program is recorded. The information input program can also be acquired from a network.

The entire disclosure of Japanese Patent Application No. 2005-369191, filed Dec. 22, 2005 is expressly incorporated by reference herein.

What is claimed is:

1. An information input system comprising:
a projector capable of protecting an operation screen image for making an input operation of information to a computer; and
an image pickup device capable of sending picked-up image data acquired by picking up the operation screen image to the computer,
wherein, as a predetermined position on the operation screen image is designated with a designating unit as the input operation, the designated position is detected as an input operation position on the basis of the picked-up image data, and a pointer is displayed at the detected input operation position by the projector, and
the information input system further including:
a standstill period determining unit that finds a time period during which the designating unit holds a standstill state at the input operation position as a standstill period, and determines whether the found standstill period has reached a predetermined time period or not; and
an input operation information generating unit that generates input operation information indicating that an input operation at the input operation position has been executed if it is determined that the standstill period has reached the predetermined time period.

2. The information input system according to claim 1, further comprising an input operation display control unit that makes a display to show the operator that the input operation has been executed if it is determined that the standstill period has reached the predetermined time period.

3. The information input system according to claim 2, wherein when the input operation is an operation of moving the designating unit from the input operation position corresponding to the start of the input operation to an input operation position corresponding to the end of the input operation, the input operation display control unit makes different displays at least between the input operation position corresponding to the start of the input operation and the input operation position corresponding to the end of the input operation.

4. The information input system according to claim 2, wherein the display to show the operator that the input operation has been executed is made in such a manner that the pointer is displayed to the operator with a visually perceptible change.

5. The information input system according to claim 1, wherein the standstill period determining unit has a standstill state determining function that determines whether or not the designating unit is in a standstill state at the input operation position, and the standstill state determining function determines whether a shift of the designating unit from the input operation position is within a predetermined range in the predetermined time period, and determines that the designating unit is in a standstill state at the input operation position if the shift from the input operation position is within the predetermined range.

6. The information input system according to claim 1, wherein the designating unit is the operator's fingertip and the input operation position is detected by detecting the fingertip.

7. An information input method for an information input system that includes a projector capable of projecting an operation screen image for making an input operation of information to a computer, and an image pickup device capable of sending picked-up image data acquired by picking up the operation screen image to the computer, and in which as an operator designates a predetermined position on the operation screen image with a designating unit as the input operation, the designated position is detected as an input operation position on the basis of the picked-up image data, and a pointer is displayed at the detected input operation position by the projector, the information input method comprising:
finding a time period during which the designating unit holds a standstill state at the input operation position as a standstill period and determining whether the found standstill period has reached a predetermined time period or not; and
generating input operation information indicating that an input operation at the input operation position has been executed if it is determined that the standstill period has reached the predetermined time period.

8. An information input program for an information input system that includes a projector capable of projecting an operation screen image for making an input operation of information to a computer, and an image pickup device capable of sending picked-up image data acquired by picking up the operation screen image to the computer, and in which as an operator designates a predetermined position on the operation screen image with a designating unit as the input operation, the designated position is detected as an input operation position on the basis of the picked-up image data, and a pointer is displayed at the detected input operation position by the projector, the information input program enabling the computer to execute:
finding a time period during which the designating unit holds a standstill state at the input operation position as a standstill period and determining whether the found standstill period has reached a predetermined time period or not; and
generating input operation information indicating that an input operation at the input operation position has been executed if it is determined that the standstill period has reached the predetermined time period.
